(19) United States
(12) Patent Application Publication
(10) Pub. No.: US 2016/0019477 A1
(43) Pub. Date: Jan. 21, 2016

(54) Axis-based workflow visualization for conveying workflow characteristics on a media device

(71) Applicant: Scott Paul Reida, Marietta, GA (US)

(72) Inventor: Scott Paul Reida, Marietta, GA (US)

(21) Appl. No.: 14/332,369

(22) Filed: Jul. 15, 2014

(51) Int. Cl. G06Q 10/06

(52) U.S. Cl. CPC G06Q 10/0633

(57) ABSTRACT

The invention, which is a form of a process map, will be referred to as a wastemap. It is a diagram associated with a process map, or prior art, developed in another location and is to provide a visual representation of the information in a more concise and understandable manner. The wastemap is generated by equating categories and steps within the process map to one or more shapes, typically lines. These shapes will have one serve as the first axis from which associated shapes will originate. These shapes may also vary in attributes based on the characteristics of the originating process map steps. A wastemap is to be generated in a non-transitory computer readable medium.

### BACKGROUND OF THE INVENTION

The present invention applies primarily in the field of performance improvement, where a natural tool applied is to develop a map of the process in question. It relates to a method for generating a wastemap. Prior art, or current method to a present process map, as shown in FIG. 4, suffers in that practitioners take photographs, make small illegible images, or incorporate other reproductive visual means to the extent that they are unusable for anything other than a general glimpse of the general size and scope. A better method to convey process performance at-a-glance is needed. This is the purpose of the wastemaps invention. Wastemaps provide considerable amounts of information in a small space, while allowing the viewer to comprehend much of the information quickly.

Wastemaps are composed of shapes, which are located in-line or at an angle to one another to form the wastemap. Individual steps within process maps are typically graded as a category based on whether they are “Value Added” (VA), “Non-Value Added” (NVA), or “Business Needed” (BN), with the desire typically to reduce the NVA steps to the maximum extent possible. It is important to convey the degree to which a process is composed of such categories. Wastemaps provide a method of visualization to quickly ascertain both the ratio and the timing of each. Note that process steps can be labeled with designations other than those given. The wastemap would still be developed in a similar manner, just with each axis representing a different category.

The current means is typically to color the individual steps green (VA), yellow (BN) or red (NVA). This falls short in presentations when the process map, which frequently spans several office walls, is condensed onto a single-paged document. Black and white presentations, which are common, omit the differentiation provided by coloring as well.

There is also another problem with the prior art. There is not a method to truly understand at-a-glance how much of a contribution each of the steps contributes to the overall process. Also, it is not possible to truly see how the different states are distributed throughout the process.

Finally, the magnitude, or impact, of each step to the process is not visible in the legacy method. This is typically provided on additional graphics, or in text form accompanying the process map visual. The current invention conveys this information simply by varying the attributes of the shape, such as thickness.

Wastemaps may be used as small graphics embedded in a document, such as a text document or a spreadsheet, among the words, numbers, images or other content of the document. By presenting a wastemap in context within the document, as opposed to presenting the graph on a separate page or screen, a viewer can more readily appreciate the information represented and/or compare the represented information with that represented by other wastemaps. Wastemaps may be generated within a single cell, or created in a larger form and reduced in size to fit the desired space. The wastemap could also be configured to be regenerated when one or more of the input values in the source change.

In particular embodiments, computer system 100 includes a processor 102, memory 104, storage 106, an input/output (I/O) interface 108, a communication interface 110, and a bus 112. In particular embodiments, processor 102 includes hardware for executing instructions, such as those making up a computer program. Where appropriate, processor 102 may include one or more arithmetic logic units (ALUs); be a multi-core processor; or include one or more processors 102. In particular embodiments, memory 104 includes main memory for storing instructions for processor 102 to execute or data for processor 102 to operate on one or more memory buses (which may each include an address bus and a data bus) may couple processor 102 to memory 104. Bus 112 may include one or more memory buses, as described below. In particular embodiments, one or more memory management units (MMUs) reside between processor 102 and memory 104 and facilitate accesses to memory 104 requested by processor 102. In particular embodiments, memory 104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM.

In particular embodiments, storage 106 includes mass storage for data or instructions. As an example and not by way of limitation, storage 106 may include an HDD, a floppy disk drive, flash memory, an optical disc, a magneto-optical disc, magnetic tape, or a Universal Serial Bus (USB) drive or a combination of two or more of these. Storage 106 may include removable or non-removable (or fixed) media, where appropriate. Storage 106 may be internal or external to computer system 100, where appropriate. In particular embodiments, storage 106 is non-volatile, solid-state memory. In particular embodiments, storage 106 includes read-only memory (ROM).

### SUMMARY OF THE INVENTION

It is the object of the present invention to provide a method for generating a wastemap to enable practitioners to easily convey the health and/or current status of a process in an at-a-glance view. The shape of the individual shapes can be a variation of a shape, being flat, with varying thicknesses, and/or varying angles.

The prior art, or current practice, results in what is depicted in FIG. 4. The current invention converts this to the shape-based version, or wastemap as what can be seen in FIG. 6. Each process step time, or cycle time as it is traditionally described, is equivalent to a specific shape length within the wastemap. For example, the shape representing a step with a cycle time of 10 minutes will be exactly twice as long as one of 5 minutes.

The wastemap is shown with two axes. The most important being what is traditionally viewed as the x-axis. This represents in the example what are deemed VA steps. Most define VA steps as those that are desired and/or requested by the customer. Variations of this definition to exist. The perpendicular axis, which is traditionally referred to as a y-axis, is split into two halves: above and below the VA line. The section above, or traditional positive y values, represents BN steps. The values below, or traditional negative y values, represent the NVA steps. Note that the categories, such as VA, can vary based on the preferences of the practitioner. Note that additional categories may exist as well and that any of these categories could populate a third dimension, or z-axis, as shown on FIG. 13.

The lines representing each of these steps are sequential. They are arranged such that the line for each process step, regardless of designation, is represented in the wastemap as it occurs in the overall process. This enables the viewer of the wastemap to know when the types of process steps (VA, NVA or BN) occur. Note that the start time may be rounded up or down to the nearest endpoint as needed to facilitate generating the wastemap for the practitioner.

FIG. 6 displays the same information as FIG. 4. FIG. 6 represents how the invention presents it as an at-a-glance view, with a quick understanding of the approximate ratio of each type (VA, NVA and BN), along with an idea of where each occurs during the lifetime of the process (based on where the y-axis lines come up or down from the x-axis).

It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

FIGS. 1-4 represent the prior art, or current practice.

FIGS. 5-6 demonstrate the calculations and layout of the invention.

FIGS. 7-9 demonstrate that the invention can be used to present each swimlane, or group involved, individually by showing the calculations involved in developing it.

FIG. 10 shows FIG. 6 with varying line thicknesses; of which the lines are varied in this example as a notional representation to present the idea that an additional burden for each step can be incorporated in addition to the cycle time, which is shown as the line length.

FIG. 11 is a notional example to show what a more complex process might look like when developed.

FIG. 12 is a notional example similar to that shown in FIG. 11, except as a more ideal case, where the volume of steps outside those defined as VA is less significant.

FIG. 13 is a notional example showing what a wastemap could look like using the x, y and z axis.

FIG. 14 represents the prior art, where multiple processes will naturally be part of a higher-level process.

FIG. 15 is a notional example, showing multiple wastemaps, as would result from FIG. 14.

FIG. 16 represents a computer system, similar to that which would be utilized.

### DETAILED DESCRIPTION OF THE INVENTION

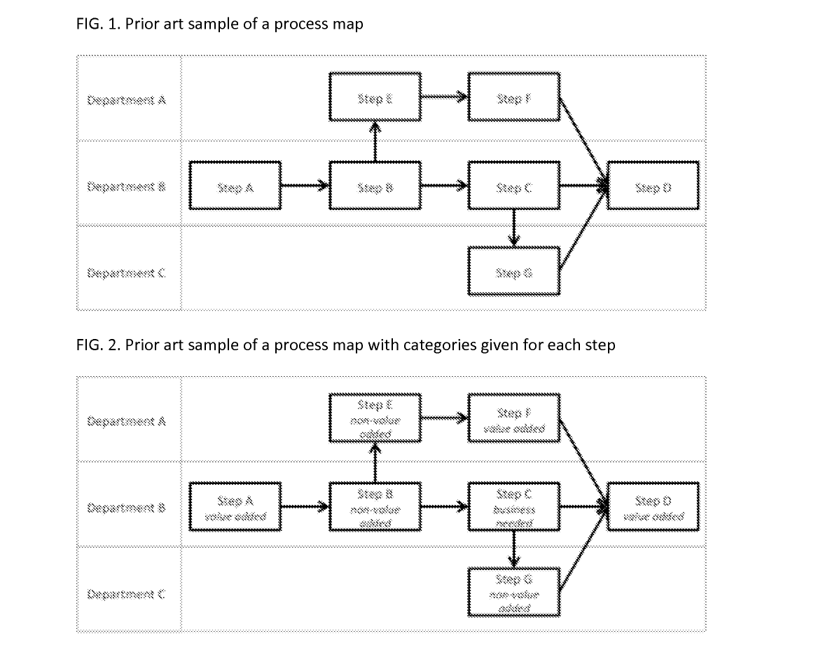

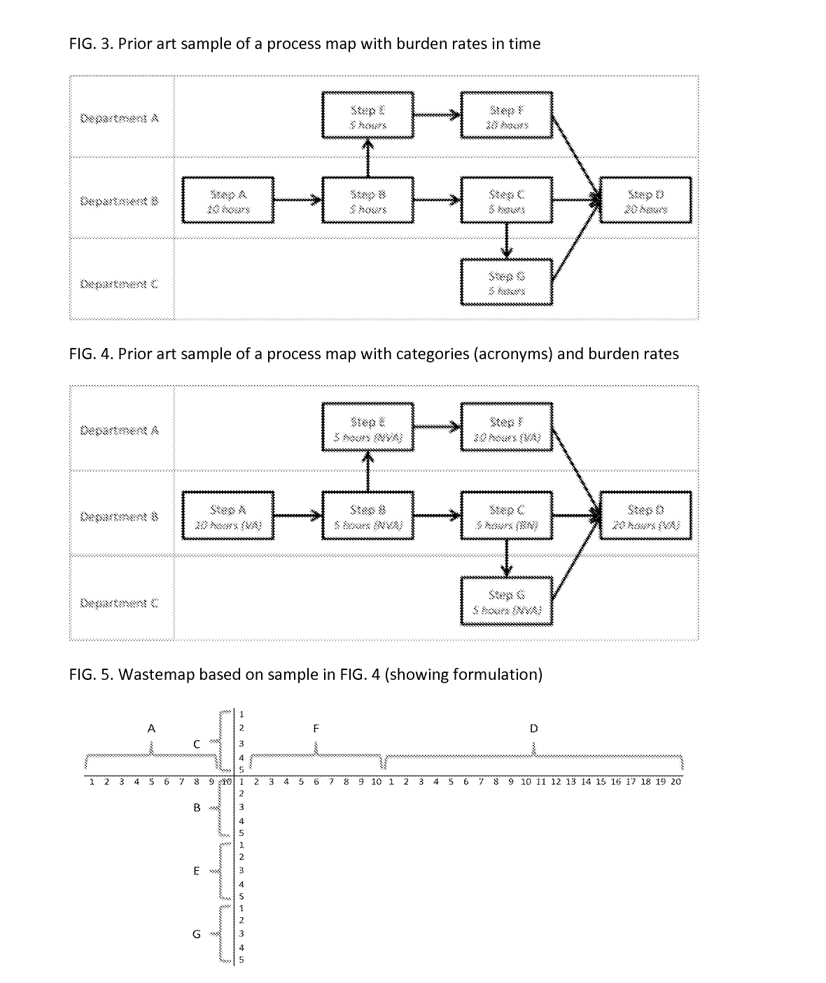

As outlined earlier, FIGS. 1 though 4 present the prior art, or current practice. This practice is within the skill set of those practitioners completing process mapping/workflow diagrams. The industry, or occupation, can vary considerably, but is commonly within the practice of performance improvement.

A significant shortcoming of the prior art is the cumbersome and illegible nature of the visuals available for presenting the process map/workflow to clients/users. The different categories, as described here as VA, NVA and BN, are differentiated from one another in the prior art. Labels or different colors being assigned to each process steps typically accomplish this. The time to complete each step, or cycle time, is also frequently included. This is typically met by writing the value within the step box. As process maps frequently fill multiple walls within an office, it becomes difficult to not only translate the images into a sharable and portable version, but also lack the ability to share the large volume of data quickly. This is the primary benefit achieved by the wastemap invention; it allows considerable amounts of data to be conveyed quickly in a simple fashion.

The primary outputs from the prior art necessary to develop the current invention are the categories (VA, NVA and BN) for each step, along with the time required to complete each step.

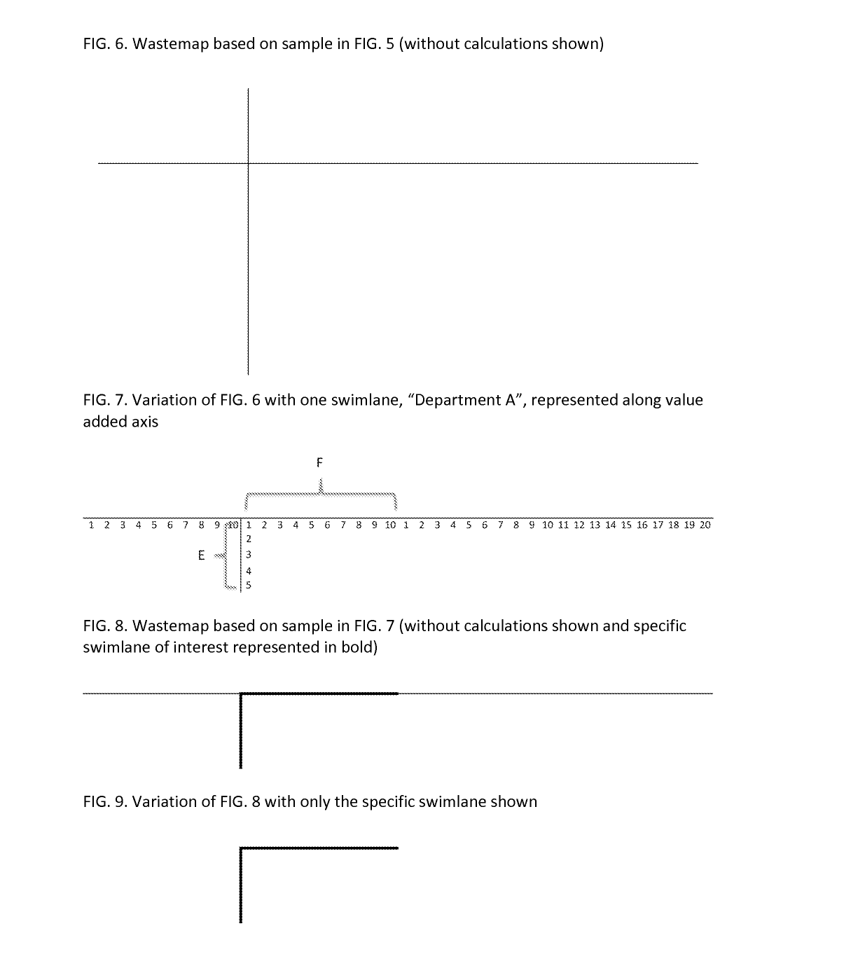

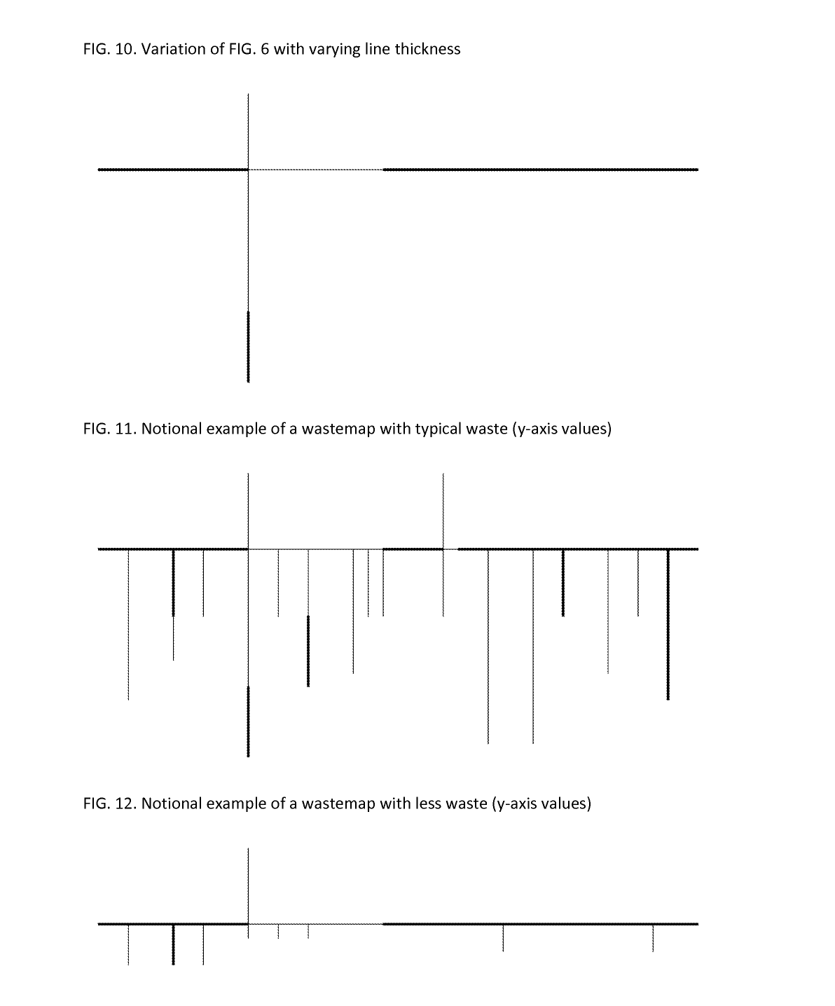

FIG. 5 demonstrates how to develop the wastemap invention based on the prior art inputs. An initial step is to separate out the VA steps and determine how much time is devoted to them. This will be the length of the primary, or x-axis, of the wastemap. Note that the lengths will remain consistent for time for all steps. In the example shown as FIG. 5 there are five VA steps, A, F and D. They have cycle times of 10, 10 and 20 for A, F and D, respectively. This total length of 40 in time will be equal to 40 equivalent units of length in the wastemap. In some cases, the practitioner may choose to limit the time to a maximum value to facilitate the development of the wastemap. An example of such a case could be a waiting period of months, where the remainder of the process steps are in single days.

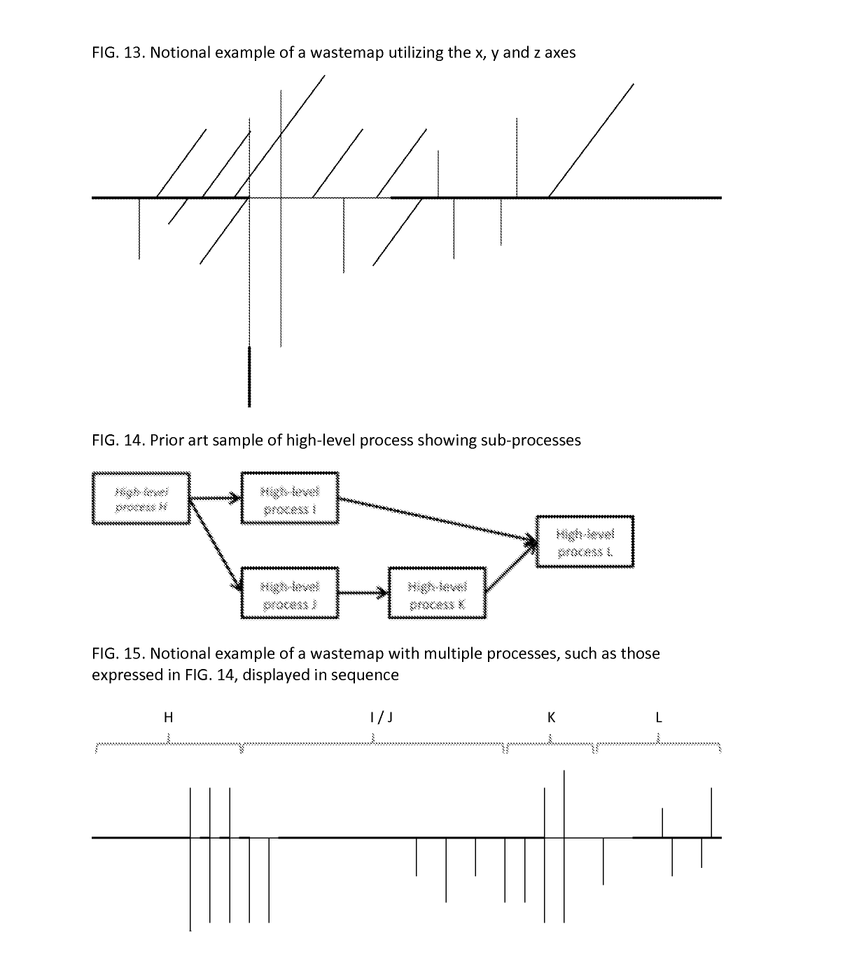

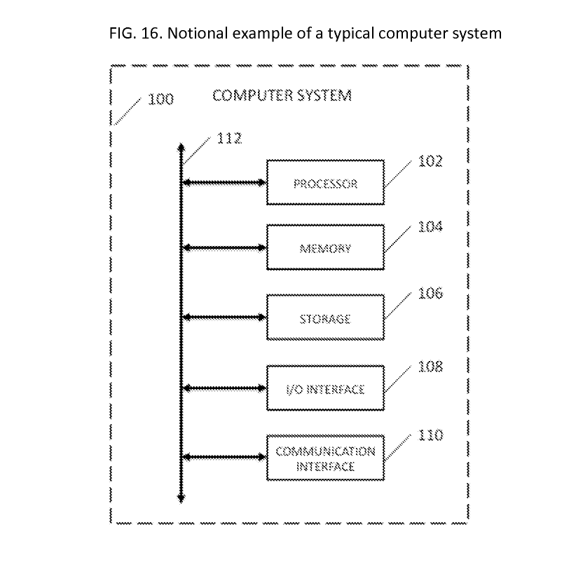

Another step is to assign an axis to the other categories. In FIG. 5 there are two other categories given and they are assigned such that the negative y-axis is the NVA steps and the positive y-axis is the BN steps. Note that there may be even more, or possibly fewer, categories for any given process. In cases where there are fewer, only have one direction, negative y-axis for instance, assigned. The other axes will simply not be populated. For cases with more than three categories, additional axes can be incorporated, such as diagonally on the z-axis, as shown in FIG. 13.

Another step is to do a similar step as that mentioned earlier where step completion times are put along the primary axis. It is essential in this step to ensure each item is put in sequence, as it occurs along the primary axis. Note that multiple steps will stack up along these axes, as more than one step may occur prior to the next step occurring along the primary axis. This is the case demonstrated in the example given in FIG. 5. There are three NVA steps in the example, B, E and G. All of these occur after the VA step A and prior to the VA step F. Therefore, all three of these NVA steps are stacked in one position. Note that the length is equivalent to 15 total units of length, as the total cycle time for all three combined is 15. The same routine is followed for the BN step, C. Note that additional categories could exist, and would be completed in a similar fashion as the NVA and BN categories were completed in this example and as represented in FIG. 5.

Individual swimlanes can also be focused on as well. FIGS. 7 and 8 demonstrate this, showing how a specific group, or department, could be presented along the primary axis. Note that any one group, or department, may not necessarily have any contributions to the primary axis. Along that claim, it may have only primary axis contributions as well. FIG. 9 presents how the single group would appear in a presentation without the primary axis contributions (as given by other groups). Note here that the primary axis is shown where a contribution to the primary axis was from the group being presented.

FIG. 10 shows another variation that can occur. Note that the thickness of the lines varies. This could be due to any form of burden rate chosen by the practitioner. The form of variation in the line can vary as well based upon personal preference. For instance, the line can be dashed, colored differently, or other means that would permit differentiation from other points along the wastemap.

FIG. 15 demonstrates that prior art techniques exist, as shown in FIG. 14, to show several sup-processes at a higher-level view, and that this could be translated into a wastemap as well. Note that some sub-processes may occur prior to the start of a following sub-process, as is the case with I and J.

What is claimed is:

1. A computer-implemented method for generating a visual media, the method comprising:
generating a flowchart to represent a sequence of operations;
designating each operation in the sequence with a first category and a first burden rate;
converting the flowchart into a axis-based workflow visualization;
assigning the first category to a first axis;
translating the first burden rate to an equivalent quantity along the first axis associated with the first category;
assembling each operation in sequential order along the first axis.

2. The method of claim 1 for generating a visual media, further comprising superimposing additional content in the associated location, wherein:
the axis-based workflow visualization is presented in a foreground of the associated location relative to the additional content such that the additional content is viewable where the additional content is not overlapped by the axis-based workflow visualization;
the axis-based workflow visualization is presented in a background of the associated location relative to the additional content such that the axis-based workflow visualization is viewable where the axis-based workflow visualization is not overlapped by the additional content; and
one or more of the axis-based workflow visualization and the additional content is at least partially transparent to allow the axis-based workflow visualization and the additional content both to be viewable when the axis-based workflow visualization and the additional content overlap.

3. The method of claim 1 for generating a visual media, comprises a presentation option, wherein the presentation option comprises:
a margin size between an outside of the axis-based workflow visualization and one or more edges of a perimeter of the associated location;
a axis-based workflow visualization color;
a background color;
a axis-based workflow visualization pattern;
a background pattern;
a highlight applicable to one or more qualifying data values;
a line thickness; and
a line pattern.

4. The method of claim 1 for generating a visual media, wherein the flowchart includes a range of cells in a process visual media document using one or more relative references such that:
the axis-based workflow visualization continues to represent the one or more data values included in the flowchart when one of the axis-based workflow visualizations and the flowchart is moved; and
a copy of the axis-based workflow visualization is created to represent data in a second flowchart when one of the axis-based workflow visualization is copied to an additional location and a second range of cells is inserted adjacent to the range of cells included in the flowchart.

5. The method of claim 1 for generating a visual media, wherein axis-based workflow visualization presentation are arranged such that:
one or more axis-based workflow visualizations can be presented superimposed over one another to facilitate comparisons among them.

6. The method of claim 1 for generating a visual media, wherein one or more axes of the axis-based workflow visualization are assigned such that:
one or more axes of the axis-based workflow visualization are used to represent categories, or types, from the process visual media source;
one axis, or first category, as the first axis, along the x-axis, or the axis along which other axes, y and z, will originate.

7. The method of claim 1 for generating a visual media, wherein one or more axes of the axis-based workflow visualization are arranged such that:
one or more axes along the first axis are arranged in chronological order;
one or more axes may have chronological placement rounded up or down as needed to facilitate development of the axis-based workflow visualization for the practitioner.

8. The method of claim 1 for generating a visual media, wherein one or more axes of the axis-based workflow visualization are arranged such that:
the additional axes, y and z, are generated using the flowchart for categories in addition to the first category represented on the first axis.

9. The method of claim 1 for generating a visual media, wherein one or more axes of the axis-based workflow visualization are arranged such that:
configuring the axis-based workflow visualization to be updated, such that:
the axis-based workflow visualization is regenerated when one or more of the input values in the flowchart change; and
the one or more presentation options are maintained when one or more document attributes are changed.

10. A non-transitory computer readable medium which stores a visual media program when executed by a computer performs:
generating a flowchart to represent a sequence of operations;
designating each operation in the sequence with a first category and a first burden rate;
converting the flowchart into a axis-based workflow visualization;
assigning the first category to the first axis;
translating the first burden rate to an equivalent quantity along the first axis associated with the first category;
assembling each operation in sequential order along the first axis.

11. A visual media generating apparatus comprising:
a flowchart generating unit for representing a sequence of operations;
a input unit for inputting a first category and a first burden rate;
a conversion unit for converting the flowchart into a axis-based workflow visualization;
a category output unit for assigning the first category to the first axis;
a burden output unit for translating the first burden rate to an equivalent quantity along the first axis associated with the first category;
a control unit for assembling each operation in sequential order along the first axis.
